(19) United States
(12) Patent Application Publication
(10) Pub. No.: US 2019/0370916 A1
(43) Pub. Date: Dec. 5, 2019

(54) PERSONALIZED DINING EXPERIENCES VIA UNIVERSAL ELECTRONIC FOOD PROFILES

(71) Applicant: DietaryDNA, LLC, Wilmington, DE (US)

(72) Inventors: Mark H. Surkin, Ardmore, PA (US); Dana B. Hoffer, Media, PA (US)

(21) Appl. No.: 16/431,057

(22) Filed: Jun. 4, 2019

Related U.S. Application Data
(60) Provisional application No. 62/680,270, filed on Jun. 4, 2018.

(51) Int. Cl. G06Q 50/12; H04L 29/08; G06Q 10/06

(52) U.S. Cl. CPC G06Q 50/12; G06Q 10/06315; H04L 67/306

(57) ABSTRACT

A computer-implemented method for selecting meals for a user includes creating a food profile comprising a first set of tags describing one or more of dietary restrictions, preferences, special diets and dietary habits associated with a user. A business profile is created that includes a second set of tags describing a plurality of meals served by a business. A matching process may then be performed using the food profile and the business profile to identify one or more of the meals meeting at least one of the dietary restrictions, the preferences, the special diets, and the dietary habits of the user specified in the food profile.

### RELATED APPLICATIONS

This application claims the benefit of priority of U.S. Provisional Patent Application Ser. No. 62/680,270, filed on Jun. 4, 2018, the entire contents of which are hereby incorporated by reference herein.

### TECHNOLOGY FIELD

The present invention relates generally to methods, systems, and apparatuses related to generating, managing, and utilizing personalized electronic food profiles to facilitate hyper-personalized dining experiences. The technology may be applied to manage dietary restrictions, preferences (for and against certain foods or types of foods), and special diets for a variety of dining events including, without limitation, dining-in restaurant experiences, catering events, and take-out food orders.

### BACKGROUND

Currently there is no standard, easy to use method for individuals or groups to communicate their dietary restrictions to the people that prepare or coordinate their food. As a result, food preparers receive little to no advanced notice about the individual dietary restrictions, preferences, diets, and requirements of their guests. Instead, food preparers and event organizers have to rely primarily on their experience and on non-standardized information and processes to obtain accurate food counts (quantity, restrictions, requirements, preferences, etc.). Moreover, an individual must explain his or her dietary restrictions, preferences, and/or diets repeatedly to each food preparer, event organizer, or other business or entity providing food away from home. Accordingly, it is desired to create a system that facilitates the creation and use of universal food profiles that can be created by individuals and shared with businesses and other entities to efficiently communicate dietary restrictions, preferences, and special diets.

### SUMMARY

The present invention, as described in various embodiments herein, describes methods, systems, and apparatuses related to generating, managing, and utilizing personalized electronic food profiles to facilitate hyper-personalized dining experiences.

According to some embodiments, a computer-implemented method for selecting meals for a user includes creating a food profile comprising a first set of tags describing one or more of dietary restrictions, preferences, special diets and dietary habits associated with a user. In some embodiments, the food profile includes a severity measurement for each dietary restriction. In other embodiments, ingredients are identified for each dietary restriction and the first set of tags specifies whether cross-contact with the ingredients is permissible. A business profile is created that includes a second set of tags describing a plurality of meals served by a business. A matching process may then be performed using the food profile and the business profile to identify one or more of the meals meeting at least one of the dietary restrictions, the preferences, the special diets, and the dietary habits of the user specified in the food profile.

The aforementioned method may be modified or supplemented in various other embodiments of the present invention. For example, in some embodiments, the method may include generating outputs such as list of the identified meals provided to the user or a menu for the business to the user (with the menu filtered to only include the identified meals). Additionally, in some embodiments, the food profile of the user is provided to a food preparer of the business. For example, in one embodiment, the food profile is provided to the business in response to determining that the user is located within a pre-determined proximity of the business or the user is on the premise of the business (e.g., inside a restaurant). The food profile may be provided to the business with or without personally identifiable information of the user.

The matching process utilized by the method may be performed using various techniques. For example, in one embodiment, the matching process is performed using an adaptation of the stable marriage algorithm. As described in further detail herein, the values, interest, and age variables of the stable marriage algorithm can be set using information from the first set of tags and the second set of tags. For example, in one embodiment, the stable marriage algorithm utilizes an interest variable set, one or more dietary preferences of the user, and an age variable set with severity measurement corresponding to the values variable or the interest variable.

According to another aspect of the present invention, a computer-implemented method for managing user dietary restrictions associated with an event includes receiving an indication of an event scheduled for a business and identifying one or more attendees of the event. Food profiles of the attendees may be retrieved, for example, from a centralized computing system. Each food profile comprises one or more tags describing one or more of dietary restrictions, preferences, special diets and dietary habits of an attendee. The business can then be notified of any dietary restrictions, any preferences, any special diets, and any dietary habits of the attendees specified in the food profiles. Notably this process can be performed instantaneously without having to individually contact or query each attendee. Moreover, in the event that an attendee makes a change to any food profile information, that change can be communicated immediately to the business.

According to another aspect of the present invention, system for managing dietary restriction, preferences, special diets, and/or dietary habits information comprises a database and one or more computers. The database stores a food profile comprising a first set of tags describing one or more dietary restrictions, preferences, special diets, and dietary habits associated with a user. Additionally, the database stores a business profile comprising a second set of tags describing a plurality of meals served by a business. The computers are configured to identify one or more of the meals meeting any dietary restrictions, any preferences, any special diets, any dietary habits of the user using the food profile and the business profile. In some embodiments, the system further includes one or more physically printed items for notifying staff of the business of the dietary restrictions associated with the user when the user places a meal order with the business.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides a brief overview of a system for sharing dietary information, according to some embodiments;

FIG. 2 provides an example of the flow of data that is used in performing menu matching and other personalized dining functionality, according to some embodiments;

FIG. 3 illustrates how events can be created and be processed, according to some embodiments;

FIG. 4 illustrates an example of the token-based system described above;

FIG. 5A provides a first example of a graphical user interface (GUI) that may be used in some embodiments of the present invention;

FIG. 5B provides a second example of a GUI that may be used in some embodiments of the present invention;

FIG. 5C provides a third example of a GUI that may be used in some embodiments of the present invention;

FIG. 5D provides a fourth example of a GUI that may be used in some embodiments of the present invention;

FIG. 5E provides a fifth example of a GUI that may be used in some embodiments of the present invention;

FIG. 5F provides a sixth example of a GUI that may be used in some embodiments of the present invention;

FIG. 5G provides a seventh example of a GUI that may be used in some embodiments of the present invention;

FIG. 5H provides an eighth example of a GUI that may be used in some embodiments of the present invention;

FIG. 5I provides a ninth example of a GUI that may be used in some embodiments of the present invention; and

FIG. 6 illustrates an exemplary computing environment within which embodiments of the invention may be implemented.

### DETAILED DESCRIPTION OF ILLUSTRATIVE EMBODIMENTS

The following disclosure describes the present invention according to several embodiments directed at methods, systems, and apparatuses related to generating, managing, and utilizing personalized electronic food profiles to facilitate hyper-personalized dining experiences. More specifically technology is described herein for providing a personalized dining experience to an individual or a group by combining guest(s) food profile data with existing and user-generated transactions and content, both internal and third-party. Food profile data may be entered by the user as items and attributes. An item refers to an ingredient or dietary restriction or preference (e.g., “almonds,” “gluten,” “vegan,” etc.) an attribute describes the associated dietary restriction (e.g., “ingredients cannot be made in a facility that processes peanuts” or “no cross-contact”). This allows various dietary information to be supplied such as ingredients, groups of ingredients, nutrients, dietary rules, portion sizes, and common diets. Items in a user's profile may be categorized for context and level of severity. User generated transactions include any dining event, such as a catering order, restaurant reservation, event invitation, dinner party, or more. User generated content includes items like ratings, reviews, recommendations, shares, images, and other social media and online sources. The system can combine this data for one or more individuals and provide personalized recommendations for dining experiences, and also provides private cooks, organizers, and hospitality and other types of businesses with actionable data to further personalize the dining experience. The system is a universal electronic food profile that can simultaneously communicate with any other internet-connected system.

### System Overview

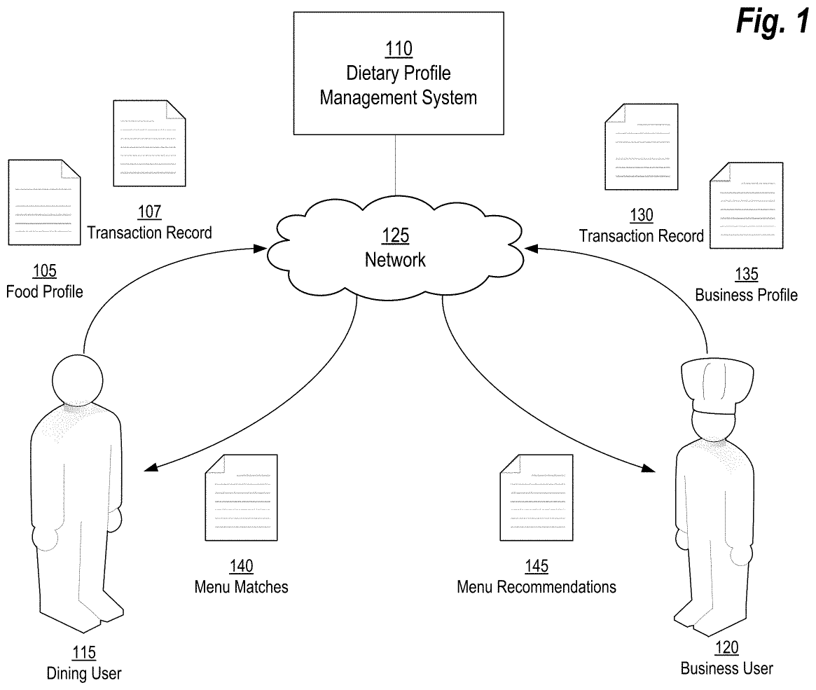

FIG. 1 provides a brief overview of a system for sharing dietary information, according to some embodiments. Briefly, a Dining User 115 and a Business User 120 each transmit profile information to a Dietary Profile Management System 110 (also referred to herein as the “DPMS” or simply as the “system”). Based on the profile information, the system provides reporting and identifies menu items offered by the Business User 120 that meet, do not meet, and/or partially meet the dietary requirements of the Dining User 115.

The Dining User 115 and the Business User 120 may communicate profile information and other data with the DPMS 110 using any technique generally known in the art. For example, in some embodiments, the Dining User 115 interfaces with the DPMS 110 using an app (native or browser-based) on a mobile device such as a smartphone. The Business User 120 may similarly use a mobile device, or may use a different computing device such as a personal computer. In the example of FIG. 1, data is transferred via Network 125. This Network 125 may be implemented, for example, using the Internet or a private intranet. It should be noted that the system described herein is not limited to digital transmission techniques. For example, in some embodiments, menu information or other profile data may be provided by the Business User 120 in paper form for scanning and storage at the DPMS 110.

The Food Profile 105 supplied by the Dining User 115 comprises a collection of data points describing how the Dining User 115 eats. This profile may include, for example, a user-generated profile made up of food restrictions and requirements (e.g., allergies, intolerances, preferences, etc.), common diets, food likes and dislikes, nutritional needs and goals, medically relevant dietary needs, and other dietary criteria. The Food Profile 105 may also include data from existing and future user—generated or business—generated transactions and content, both internal to the system provider and via third-party integrations and data access. This profile is built using the profile items directly and/or system tags that are linked in the DPMS 110 database to any item in the Food Profile 105. In general, any type of data may be used as a tag. Non-limiting examples of tags include express dietary restrictions (“gluten-free,” “dairy-free”, etc.) and metadata such as a recipe or a recipe source.

As one example, the Food Profile 105 of the Dining User 115 may specify information such as a severe allergy to peanuts; moderate gluten sensitivity, but soy sauce and slight cross-contact are okay; heart healthy foods are generally preferred; loves grilled vegetables; loves Mexican flavors; does not like mushrooms; prefers medium portions (600-800 Calories per meal); eats out 6.4 times per week and often dines at Mexican restaurants (based on dining and search history stored by the Dietary Profile Management System 110; is a member of Springfield Country Club; works at Deloitte in Philadelphia, Pa.; attended Bryn Mawr College; has 2 children; lives in 19003 zip code.

The Dining User 115 also includes a Transaction Record 107 within the DPMS 110. This Transaction Record 107 includes information describing transactions between the Dining User 115 and various hospitality organizations. For example, the Transaction Record 107 may include catering orders, private party information, restaurant reservations, takeout/delivery orders, hotel/resort stay information; and grocery purchase records. It should be noted that transactions may be sent to the DPMS 110 as they occur, rather than aggregating them into the Transaction Record 107 at the Dining User's 115 device. Furthermore, in some embodiments, the Transaction Record 107 associated with the Dining User 115 may be partially or wholly generated at the DPMS 110 based on, for example, transaction information provided by hospitality owners (described in further detail below).

The Business User 120 supplies information for a Business Profile 135. The Business Profile 135 comprises accumulated and configured data points for each hospitality business, such as caterers, restaurants, private clubs, hotels, or other food business. Data points may include, for example, items like capabilities (e.g., as related to food restriction, requirements, and diets), menus, hours of operation, types of food restrictions and guests commonly served; ratings and reviews; descriptors of cuisine, ambiance, type, etc.; transaction history; location; linked staff; guestbook; and more. In the example of FIG. 1, the Business User 120 also supplies a Transaction Record 130 that describes transactions from the perspective of the Business User 120.

As one example, the Business Profile 135 may include (along with basic information such as name, address, price point, size, etc.): a description of food and ambiance (e.g., Farm to Table, kid-friendly, Mediterranean, wine, catering, private rooms; dietary accommodations for guests requiring “no cross-contact” or “Strict diets”: dairy, peanuts, Kosher, Vegan; dietary accommodations that the business can make a best effort to accommodate: gluten, heart healthy, diabetic, soy; commonly serves individuals aged 25-35, serves average of 150 covers per night; has rejected 10 severe wheat allergies and 5 severe egg allergies.

In some embodiments, the system supports separate managed profiles for those under a primary user's care. The system allows individual users to build a separate food profile for another individual he or she cares for such as a child or elderly family member. The system may do this by linking the primary user account as the owner of the secondary (or tertiary) user's profile within the system database. The primary user can then build and manage the secondary user's profile data as necessary. An example of this functionality is a mother (Jen) whose 7-year old daughter (Sally) has a peanut allergy and a dairy allergy. The mother builds her own system profile, and adds a secondary profile labelled as “Sally Smith” which mom can then share out separately or together with her own profile, and then manage related transactions.

The system cross-matches the data in user profiles with business profiles to provide personalized recommendations for dining experiences (for the individual or for a group) in the form of restaurant or caterer recommendations, Menu Matches 140, and other relevant suggestions. These Menu Matches 140 may include, for example, a listing of menu items that fit the dietary requirements of the Dining User 115 or a list of restaurants offering menus that include such items. Examples of personalized recommendations include lentils for a vegetarian, gluten free rolls for gluten intolerant people; and fish, rice, and asparagus for a gluten-free pescetarian that is kosher. Additionally, in some embodiments, the system uses the profile data to provide the Business User 120 with actionable data, advice, and recommendations to further personalize the dining experience (collectively, referred to as Menu Recommendations 145 in FIG. 1). The system shown in FIG. 1 thus provides a universal electronic food profile, or electronic dietary record, or food profile management system that can communicate with any other internet-connected system, simultaneously, to coordinate a highly personalized dining experience.

In some embodiments, users of the system can be matched individually or in groups to hospitality businesses, other users, groups of users, businesses, foods, recipes, and prepared foods, also accounting for location and other demographically relevant data. In the case of foods, recipes, and prepared foods, the data in a user's profile is simply matched to the item in question and a percentage matched value is returned. A match can be full, partial, or none. The system can use this information to suggest food items, recipes, ingredients and product substitutions, and consumer packaged goods products for purchase. Examples might include a recipe for vegan pancakes, how to replace eggs when baking for vegans, a specific Consumer Packaged Good (CPG) brand egg replacement product, or even a contextual recommendation indicating to a restaurant that they have “5 vegans coming tonight, here's a vegan ice cream recipe or CPG product.” In the case of hospitality businesses like restaurants, caterers, hotels, and resorts, each business builds a profile indicating their capabilities as they relate to food restrictions, preferences, requirements, and diets. This profile is built using system tags that are linked in the DPMS database to any item in a user's food profile. Further, these tags can be categorized by whether the business can guarantee against ingredient cross-contact, or simply make a best effort towards keeping it off the plate. The matching process may return, for example, a percentage match value resulting in a full, partial, or null match. The matching process is done at the ingredient/nutrient level so that cross-matching is possible; for example if a user defines a Red Meat Restriction, and a restaurant adds a tag for Vegetarian, there is still a full match. The business also has the option to upload a menu either with full recipes included for matching to user profiles, or with tags on each menu item indicating restrictions and diets that item accommodates for or against. Food menus and/or product listings are automatically filtered to hide or recommend against any item that does not match the user's food profile.

In the case of matching users, groups of users, or business profiles may simply be matched to each other using the tags and linked attributes noted above, allowing the system to suggest connections with individuals, groups, and/or businesses. Location may additionally be used as a factor, enabling functionality to show the end user food businesses, restaurants, or caterers near their device's Global Positioning System (GPS) location that match the individual or group's food profile(s). The system can use Near-field communication (NFC), Bluetooth, or GPS to automatically link search results to nearby friends if those friends are connected through the system. For the business user, GPS usage enables the business to view in a list view or pinned on a map all customers or potential customers within a specified distance of the business location that match a specific type of profile. The system collects and anonymizes search data by region so that businesses can be presented with data about the types of searches/matches happening in their geographic region or other regions.

Aside from providing food matches, the system may provide the Business User 120 with various information that may be used to enhance the operation of the business. In some embodiments, the system can make intelligent suggestions and provide planning functionality for food preparers by automatically matching individual transactions and users to recipes, products, food handling techniques (e.g., made in a kitchen with or without airborne gluten,” “blackened,” “sautéed,” or “separate allergen-friendly cookware and utensils”), chat threads, and other relevant content. This may be done, for example, based on the food profile attributes linked to a transaction (or group of transactions) via the transaction's guest list(s). The system provides general information and notes for each type of food profile item, and can make intelligent recommendations based on the business profile of the hospitality business. The business user can also define additional notes or tags related to each food profile item or guest, which can then be automatically appended to future matching transactions in the system.

In some embodiments, in the case of customer walk-ins, the system may automatically notify the food preparer when a customer with a food profile enters the establishment, and provide the food profile to the food preparer (if the user has allowed this action via security permissions set via the dietary profile management system). Walk-ins may be identified, for example, by a device scan (barcode or NFC, etc.) at the host stand, or monitoring of the customer's location with GPS and notifying the business when the user is within a pre-determined proximity of the business (e.g., 100 feet) or the user is within the business itself. Alternatively, using integration with a third party mapping service such as Google Maps or transportation service such as Uber, the system can detect when the customer is traveling to the business. Examples where this technique may apply include, without limitation, private clubs, resorts, hotels, and casual restaurants. The system may use GPS location, NFC, biometric, or other modes of authentication to instantly notify the food preparer of the customer's food profile, without that customer having to verbalize their needs.

In other embodiments, the system can use a device's GPS location to notify food preparers when one or more guests involved in a reservation or catered event is nearing the venue. The business can see incoming/potential customers on a live map view. For example if Joe Smith reserves a table for 4 at X Restaurant at 7 PM, and shares 2 food profiles including a peanut allergy and a vegetarian preference, when Joe is 1 mile away, perhaps at 6:50 PM, the system can use Joe's GPS location (if enabled) to communicate to X Restaurant that he's almost there and they should heat up the vegan dinner rolls. This is contingent on Joe and his guests allowing this feature within the dietary profile management system, for privacy. This provides the ability to link one or more food profiles to specific events, either by request or by user initiation, even if those events are created on third-party systems.

In some embodiments, the system adds food profile data such as allergies and diets, along with context, level of severity, and actionable notes relevant to each individual order and food profile. A context can be, for example, that a particular item is an allergen and that the allergen will induce a life threatening response upon ingestion. The level of severity describes how severe the restriction is with words or an icon or other visual indicator (e.g., “!!!”, red color, etc.).

Data can be added to printed order tickets, kitchen display systems, or other ordering system by the Business User 120 either manually or via a system integration. Physical printed “Dish Markers” may be included with these orders so that plates, platters, and other service vessels can be marked appropriately and easily identified by staff and guests. For example an order ticket might be printed in the kitchen for a table of 6 people with their food orders. This printed version may include, for example, color coded data from the dietary profile management system directing requirements for individual dishes and guests, such as “table 12, position 2, RED Peanut Allergy (severely allergic) grilled salmon. Refer to the Peanut Allergy Checklist by the walk-in freezer!”

In some embodiments, the system can share food profile(s) and/or offer recommendations or custom-filtered menus by GPS detection, facial recognition, NFC scanning, fingerprint, or other authentication methods. For example, if a user enters a restaurant with its menu uploaded to the dietary profile management system, the system may use the device's GPS location to automatically trigger a device notification allowing the user to view that restaurant's menu, and, if available, the system may filter that menu based on the user's food profile, and even provide dish recommendations. In some embodiments, the system can use the device's GPS location to recommend local dishes or food businesses based on the user's food profile and current GPS location, and send a device notification to the user's device. In the case of restaurants with ordering kiosks, the system can use NFC, fingerprint scanning, facial recognition, or other authentication method to share the user's food profile with the ordering kiosk and present custom options.

In other embodiments, the system can intelligently and automatically confirm/deny requests on behalf of hospitality businesses based on the businesses' profile and prior activity. For example if a business does not include “Peanuts” in its profile and denies a request for a Peanut Allergy user, all future Peanut Allergy requests can be automatically blocked by the system. The business profile may be periodically queried to confirm that the restriction still exists, and the requests should be continued to be blocked. Alternatively, a change to the business profile may trigger an update process that automatically updates any automatic-responding rules.

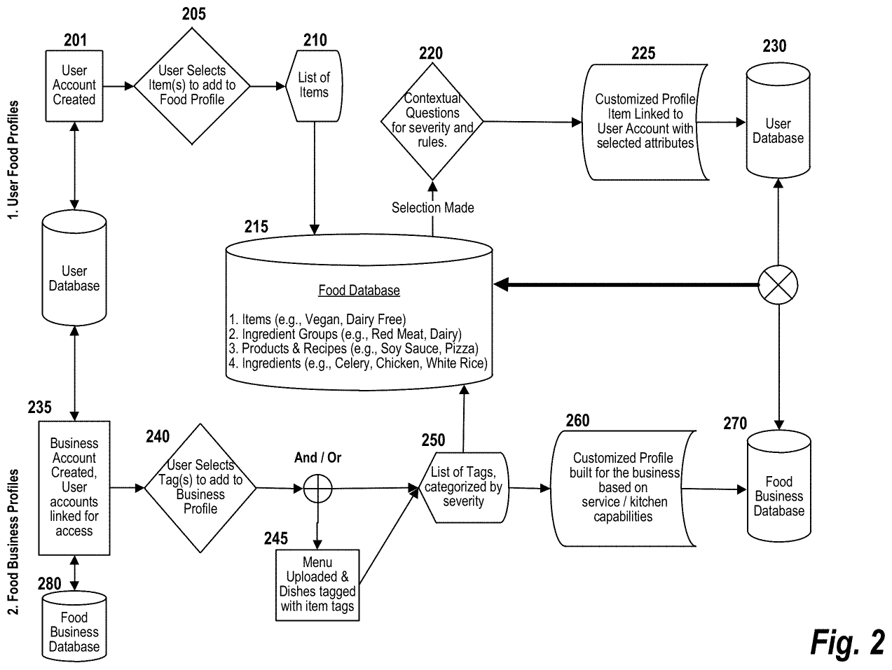

FIG. 2 provides an example of the flow of data that is used in performing menu matching and other personalized dining functionality, according to some embodiments. The upper half of the figure shows the perspective of the user food profile. At step 201, the user account is created. As described above, the user may create an account, for example, using a mobile device. For example, in one embodiment, the user supplies account information (e.g., contact information, user name, password, etc.) to a remote system via an app or website.

Once the user account is created, at step 205, the user selects one or more items to add to the food profile. This may be performed, for example, by answering a questionnaire or by entering certain food restrictions. It should be noted that an “item” in a food profile may contain generally any information that may be used to understand the user's dietary habits, needs, preferences, etc. Examples of items in a user food profile may include, without limitation, a common diet, a food restriction, a food preference, likes, dislikes, etc. A list of items 210 is generated based on the user selections at step 210. This list of items 210 may be taken directly from the form provided by the user, or it may be coded in a common format using a post-processing algorithm (e.g., a textual input of “no animal products” may be processed to be “vegan.”).

Once generated, the list of items 210 is compared to information in a food database 215 within the food profile management system to generate contextual questions for refining and supplementing the list of items 210. These contextual questions are then presented to the user at step 220. In some instances, a rules engine may be employed to determine contextual questions that should be presented to the user based on selection of certain items. Alternatively, a trained neural network or other machine learning model may be used to identify the contextual information needed to accurately describe a user's dietary preferences. For example, the neural network may be trained based on selections made by other users of the system. Assume that a past user indicated a dislike for tomatoes, but a like for tomato-based products such as ketchup and marinara sauce. In this case, if a new user indicates a dislike for tomatoes, a question may be presented to the user asking whether the dislike extends to tomato based products. In addition, the user may be queried for information describing the severity of any likes or dislikes. For example, if the user specifies a dislike for walnuts, the user may provide a severity measurement that ranks the dislike from a minimum value (e.g., 1 indicating “prefers not to eat”) to a maximum value (e.g., 10 indicating “severely allergic”). Once the user profile has been completed (i.e., with the likes, dislikes, contextual information, etc.), it is stored in a user database 230 within the food profile management system.

The bottom portion of FIG. 2 illustrates the process involved with the creation and management of business profiles (i.e., profiles associated with hospitality business owners, private chefs, caterers, hotels, event planners, etc.). In this case, starting at step 235, the business user creates a business account that may include special fields for describing the relevant business. For example, for a restaurant, a business account creation may entail providing an address, hours of operation, etc. If the business user has a personal account with the food profile management system, it may be linked to the business account at step 235 allowing for simplified login that does not require separate passwords. Once created, the business account is stored in a food business database 280 within the computing system hosting the food profile management system.

Next, at step 240, the business user selects profile items directly, or tags to add to the business profile. Each profile item has a “tag” associated with it in the food database. For example, a business user may tag their restaurant as “vegetarian-friendly” if they have meat-free entrees on the menu, or are willing to make substitutes to remove meat items from dishes. Alternatively (or additionally), at step 245 the business user can upload a digital representation of the business's menu. Then, the food profile management system can generate the tags automatically. For example, in one embodiment, the business user may upload a document with the menu as an image or PDF. Optical Character Recognition (OCR) can then be applied to extract the menu items. If ingredients are listed, these can be extracted as well. Otherwise, the system may query the user for ingredients or identify the ingredients automatically (e.g., via an ingredient database indexed based on recipe names). For example, in some embodiments, the system can predict the ingredients and recipe for a dish or other food item based on its title and description on the menu. The system may parse available online recipe sources for the most common ingredients and provide a list of likely ingredients and cooking methods based on that information. The system may use multiple content sources to aggregate data from multiple recipes for the same type of item to predict the recipe, and present it to the user with a value indicating the strength of the prediction.

Continuing with reference to FIG. 2, the severity of the tagged items is determined to yield a list of tags categorized by severity 250. The severity can be supplied manually by the business user, for example by inputting information through a GUI. Alternatively, the severity information may be determined automatically based on, for example, a trained neural network that is trained to output severity measurements based on ingredient information. In this case, the severity measurement may indicate how essential the ingredient is to the overall menu item. For example, if gluten free pasta can be prepared in pots and with utensils that do not interact with any gluten products in any way, the severity may be listed as the highest value. However, if gluten-free pasta is offered without the other guarantees, a lesser severity measurement may be used. Once the list of tags 250 is generated, it is used to update the food database 215.

The list of tags 250, along with the other business account information is used to build a customized profile 260 for the business that describes the service/kitchen capabilities of the business. Part of this business account information may include a webpage or other GUI that allows users to view the menu and tags in an easy to navigate interface. This customized profile 260 is then stored in a food business database 270 in the system. When a match is requested by the user or the business, the system looks at the selected attributes in the user and business profiles, and the system drills down to all levels within the food database 215. This ensures cross-matching even if the “items” do not match directly.

### Event Creation and Management

In some embodiments, one or more user food profile(s) can be linked to an unlimited number of events in the system, either initiated by the user or by request from other users or businesses. Events in the system can include restaurant reservations, invitations, catered events, private events, and more, and include attributes such as a guest list, venue location, time, date, name, etc. In some of these embodiments, the system can link food profiles to events created in other systems as well, for example in an online calendar or other reservation or event management platform. The system may generate a unique Universal Resource Locator (URL) that can be pasted into a text box on the external system, allowing users to link their food profile to that event. If there is a direct integration with that third party system, food profiles may be made visible in that system and details such as guest list, venue, time, and date are dynamically updated in both systems as they change, with supported changes originating from either system. If there is no direct integration, the system may keep a record of the originating system URL (if available) and generates and maintains its event record separately to aggregate food profiles of event guests.

The invitation to the user can come in the form of a food profile request which includes an RSVP request, or simply a food profile request, in cases when RSVPs are managed with other systems. The system manages this difference by toggling an RSVP option on each request, which when enabled allows guests to respond with yes/no/maybe (or event organizers to log the response manually), and when a user RSVPs with yes or maybe, the system can automatically add that to user's food profile. If the RSVP option is disabled, the user is only asked whether they want to share their food profile with the event organizer(s) (creator, host, and/or planner) and caterer(s).

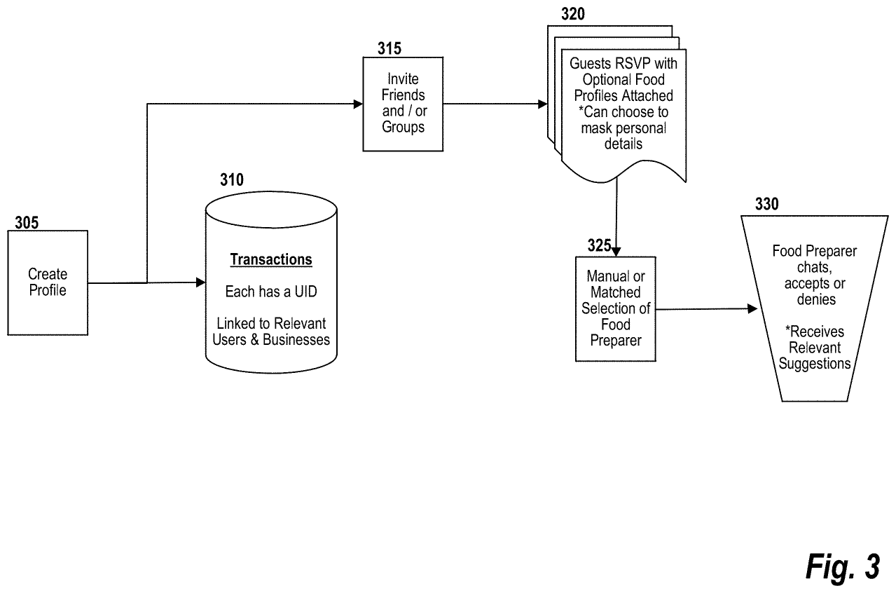

FIG. 3 illustrates how events can be created and be processed, according to some embodiments. In this context, a “transaction” refers to an event attended by one or more users and hosted by one or more businesses. A transaction can be as simple as an individual user visiting a business for a single meal, or complex as many users attending an event hosted by multiple businesses (e.g., multiple caterers).

Starting at step 305, a user or business creates an event. In some embodiments, the event may be created using an app or website operated by the food profile management system. In other embodiments, the user or business creates the event in a calendar-based system operated by an external platform (Google Calendar, Evite, etc.). Through direct integration or a plugin on the external program, an event linked to the system may be automatically created or a unique event URL can be inserted into the event details of a calendar item (e.g., “click to add your food profile: http://[shortURL]”). Once created, the event is stored in a transaction database 310. Each record in the transactions database 310 has a unique ID and links to relevant user and business profiles. In some embodiments, the system background scans all events for similar attributes and guests, notifying creators when a duplicate is suspected.

In some embodiments, the system compares guest lists, friend(s) and/or group connections of users on the guest list, dates, times, and venues of upcoming transactions to ensure against duplicates. If two or more transactions look similar, the system may notify the creator(s) of the transaction(s). For example, if User A and User B are going out to dinner together, but both create separate events in the system for the same date and time period, the system may notify the parties and suggest cancellation of the reservation request that was submitted second.

In some embodiments, the system may support a chat system that allows users to discuss an event. Chat threads initiated from an event can be automatically tagged with unique event ID for easy sorting. In some embodiments, chat threads are grouped by unique event(s), food profile data attribute(s), and/or by user or business. If a chat thread is initiated from within a system transaction such as an event or a group, that thread is tagged with the event or group's unique system identifier, and displays in the user's chat box as a new thread (even if a chat involving the same parties occurred previously). The system can also sort chat threads by food profile attributes, or by individual users, groups of users, or business(es).

Continuing with reference to FIG. 3, at step 315, the user interacts with the system to invite friends and/or groups to the event. At 320, the invited parties respond and they are linked to the event. The system may determine which parties have food profiles and link those profiles to the event. Alternatively, a party may RSVP with a link to a food profile that is then associated with the event. In some embodiments, parties can choose to mask personal details in their response. For example, a user may provide a response and a food profile, but ask that the profile remain “anonymous” such that it does not include any personally identifiable information of the user. Next, at 325 a food preparer is identified, either manually by the business hosting the event or via suggestion from the system (e.g., based on dietary information in user profiles). Once identified, the food preparer analyzes and processes the event information at step 330. This may include, for example, chatting with invitees to answer questions about the menu or ask questions about dietary requirements, accept or reject dietary requests, etc. In some embodiments, the system may provide suggestions for menu preparation based on the information in the user profiles. For example, for a catered menu offering chicken, beef, and fish options, the system may suggest quantities for each option to order for the event.

Sharing Food Profiles Between Users and with Third Parties

In some embodiments, the system described herein enables instant and simultaneous sharing and updating of one or more food profiles with one or more entities, including hospitality businesses, other users, groups of users, businesses, event planners, or other food preparers such as private or home cooks. For example, in one embodiment, a user can share his or her profile and the profile(s) of other system users (if access is permitted) with food preparers in advance of a dining event, instantaneously, simultaneously, and without verbalizing or writing or typing the details. This allows the food preparer to a) confirm or deny that they can accommodate the dietary needs of the guests, and b) receive advance notice of how guests need to eat, to better inform menu development, food prep, and service. To do this, the system aggregates the food profiles of each user attached to a dining event (e.g., a reservation, catering order, event invitation, etc.) into a simple report (interactive and printable versions available) for the food preparer sorted by factors including user attribute(s), food profile attribute(s), and/or combination(s) of food profile attributes. For example, user attributes may include whether a user is “flexible” or “strict” about a diet listed in his or her food profile (e.g., “Flexible vegan but strictly vegetarian”). The report can then group people with the same or similar attributes (e.g., all vegetarians). It should be noted that user attributes could also include other descriptors or data about the user, such as organizations they belong to, whether they are a VIP (to the specific host or food preparer), and more. This gives even more flexibility to report generation. A single user can share an unlimited number of food profiles (i.e., the user's own profile plus the profiles of other system users) with a food preparer instantly, and the food preparer can then use the system to automatically accept, or send a confirmation or denial of the transaction, or use integrated messaging for further clarification.

In some embodiments, the system supports persistent-state sharing of user profiles. If a user has already shared his or her profile to an upcoming event, and then changes the content of his or her food profile (e.g., adding a milk allergy), the user is presented with an option to instantly share that updated profile with all relevant upcoming transactions, including upcoming catered events, restaurant or hotel/resort reservations, and private parties, as well as relevant entities such as friends, co-workers, health and wellness professionals, employers, restaurants, and caterers the user has had transactions with in the past, and more. In the case of upcoming events or restaurant reservations, the business can then be given an opportunity to re-confirm (or deny) the user's updated profile. When a user shares his or her profile as part of a transaction, the system links a persistent state version of the user's profile to that transaction. If the user changes his or her profile after sharing it to a transaction, the version linked to that transaction is only updated if the user chooses to do so when prompted by the system. For example, if a user has a Heart Healthy food profile and accepts an event invitation to a wedding, the wedding caterer receives the heart healthy profile. But if the user adds gluten free to his profile, the user is asked whether he wants to update upcoming events with this change. If the user says no, the wedding caterer still only sees heart healthy. If the user says yes, the wedding caterer also sees Gluten Free.

The food profile management system can provide additional features that allow the user to share dietary information with friends and other groups, and tailor the food profile based on the user's various connections. In some embodiments, the system provides the ability to reference a food profile with a simple system handle, referred to herein as a “FoodID.” This handle can be system-generated or user-generated, and preceded with a symbol (e.g., “%”) referred to herein as the “PortionTag.” Like the hashtag, the PortionTag precedes FoodIDs to allow for simple internet lookup from any platform. The FoodID allows a user to reference and share a food profile (of any complexity) to any business or individual without actually verbalizing or writing the detail of that food profile. The system can generate a Quick Response (QR) code and/or unique URL for any FoodID. A PortionTag can denote a user, business, or key word. Examples include a user with FoodID handle % JoeSmith, a business with FoodID handle % Applebees, or a social media post with an image of a gluten-free sandwich and caption “Check out this great % glutenfree bread!”

In some embodiments, the user may specify permissions to limit what information from the profile is shared. In some embodiments, the user's food profile can be shared anonymously or with certain details masked by the system. If a user wishes to remain anonymous, the system may communicate the food profile details of the user to the food preparer using either a color code or a nickname chosen by the user or generated by the system, or the user's details may simply be included in the summary and reports with the user name masked.

In some embodiments, the user's food profile may also include an option that allows a social networking connection to the user (e.g., a button). Social networking techniques generally known in the art may be employed and may be used to record and track connections between users. Similarly, the system may track groups to which the user is connected (e.g., employer, club, family, school, etc.) as well food businesses the user is connected with, or as had past transactions with. In some embodiments, when the user updates his or her food profile, the updates are shared with all or some of the user's connections (per user choice).

### Token-Based Invitations and Single Click Profile Management

In some embodiments, the system can generate unique, token-based invitations (with or without time-based expiration) for users to sign up for an account with defined attributes directly from their e-mail inbox, online calendar, a unique URL, social media post or forum/chat share, QR code, bar code, or unique system-generated code. For example, in one embodiment, an individual that is not a current user of the system receives an e-mail invitation from her employer to sign up for the dietary profile management system and build a food profile. Within the e-mail are separate URL hyperlinks for common food profile items such as Vegan, Gluten Free, Dairy Free, Diabetic, etc. Each hyperlink includes the same unique URL with a separate string added to the end of the URL indicating the food profile attribute. When the user selects Gluten Free (for example), a user account is automatically created in the system with that user's e-mail address and adds Gluten Free to the user's food profile.

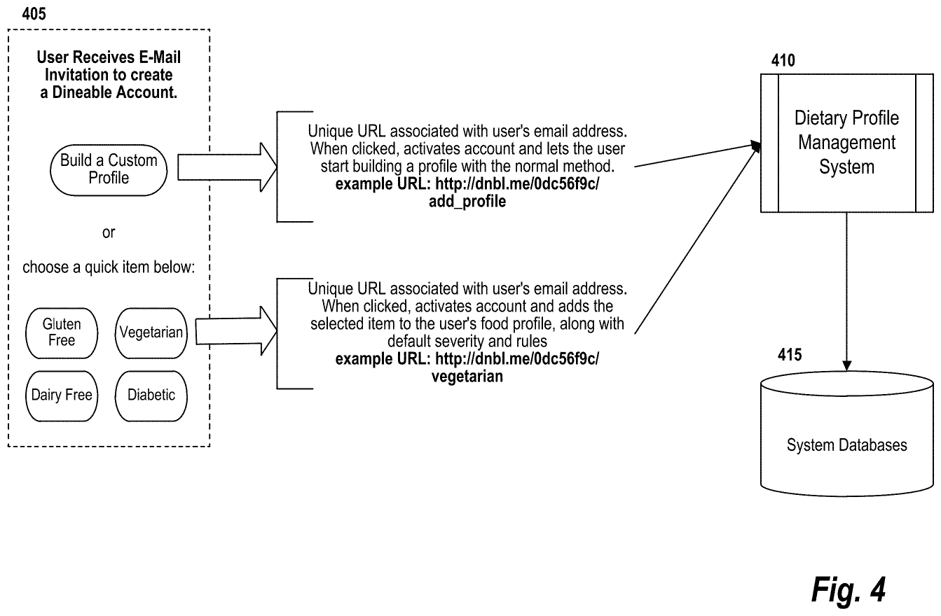

FIG. 4 illustrates an example of the token-based system described above. The process shown in FIG. 4 allows a user to activate an account and build a profile in a single click. Furthermore, this process can be used to activate an account, build a profile, RSVP to an event, and share a food profile in a single click. Assume that the interface 405 is received by the user via email. Embedded in this email are links that have unique URLs associated with the user's email address. For example, clicking on the “Build a Custom Profile” button on the interface 405 activates the user's account and lets the user start building a profile with the normal method. One example of the unique URL used in this scenario is http://dnbl.me/0dc56f9c/add_profile. The buttons at the bottom of the interface allow the user to create an account with a dietary restriction. When these buttons are clicked, the user's account is activated and the selected item(s) are added to the user's food profile, along with default severity and rules. One example of the link that can be used with “Vegetarian” button is http://dnbl.me/0dc56fc/vegetarian. Once the account is active by the Dietary Profile Management System 410, the user profile and any related information is stored in the system databases 415.

In some embodiments, the single selection system described above may be extended to food delivery, allowing an end user to order a personalized meal delivered to their default location in one click (or tap or other selection method). To choose the meal, user may simply provide a single selection of an item via, for example, tap, voice, text, etc. The system may then use all variables in the user's food profile and general profile, combined with other current demographics such as food trends (via online content both first and third party), weather, season, day of week, time of day, what friends (and other connections) are eating and ordering, current health and wellness trends and information, and more. This information may be matched with profile details of nearby food businesses offering delivery, and a percentage match may be returned. The highest match may be chosen automatically, or with user input. If the top match percentage results in a tie score, the choice may be randomized by the system.

Matching Diners and Meals with a Stable Marriage Algorithm

In some embodiments, dining users are matched to meals using an adaptation of the stable marriage algorithm. As is generally understood in the art, the “stable marriage” problem analyzes how to best match people for marriage. More specifically, for a given number and an equal number of men and women, the problem is to match the people that will likely be compatible and therefore stay married. The variables used in the stable marriage algorithm values, interests, age, and location.

The core algorithm of Stable Marriage may be adapted for meal matching by setting the algorithm's variables using menu and dining user profile information. Consider the following simplified example. A diner has the following tags in his profile “gluten free,” “vegetarian,” and “dairy free.” These can be used as “values.” Similarly, a meal may be tagged as “gluten free,” “vegetarian,” and “dairy free” by a restaurant. Using the stable marriage algorithm, the diner should be matched with the meal because the values all align. This concept can be readily scaled to any number of tags, and allow for partial matches to be identified and the similarities to be quantified. The interest field of the Stable Marriage algorithm can be used to capture concepts not available in the profile categories (e.g., “does not like Brussel sprouts”). Note that the method discussed above only uses the value and interest variables to perform meal matching. However, the age and location variables may also be adapted for use in meal matching.

Although age may not be directly relevant to diner-meal matching, the age field can be used to augment the interest field with a severity or impact measurement. For example, the age variable may be useful as a spectrum from 10 to 90 where 10 corresponds to significant issues like hospitalization likely/certain if certain items are in the meal and 90 means no issues (i.e., “eats everything”). Take the example of a healthy person that normally eats everything but expresses dislike for a few things, beginning with Brussels sprouts. In this case, the values variable would equal “eats everything”; the interests variable would indicate “dislikes Brussel sprouts”; and age variable may be set to 85 because the dislike has a very light severity or impact. As another example, consider a heart healthy individual that can eat everything but is trying hard to adhere to a way of eating. In this case, the values variable may be set to “heart healthy, low carbohydrate, eats everything;” the interests variables may be set to “no salt, no sugar, no alcohol;” and the age variable may be set to 50 to indicate that these interests have a moderate severity or impact. In the future this information may allow a chef to code a Roasted Chicken with Wine Sauce menu items as a 50 because the alcohol may evaporate during cooking.

The location variable of the Stable Marriage algorithm can be used to identify when the algorithm needs human review and assessment. For example, location in the algorithm is latitude and longitude. This two dimensional system can be used to place users according to the dietary restriction. For example, the hardest people to manage (i.e., requiring most restrictive meals) may be assigned coordinates corresponding to the upper right of the coordinate system, while the easiest to manage (i.e., “eats everything”) may be assigned coordinates in the lower left. When the algorithm sorts a large number of meals for a large number of guests, the location variable may be used to determine “which guest-meal pair are the furthest apart?” and, as necessary, designate pairings for inspection. For example, if 10 guests and meal pairs have a long distance between them, this may be identified to the user for inspection.

A challenge of the Stable Marriage algorithm is that if the guest designates a particular interest (e.g., “no Brussels sprouts,”) the chef would need to tag a meal similarly to invite a match. To address this issue, in some embodiments, the guest interests are pre-processed and the entree choices are assessed for containing the identified ingredients (i.e., Brussel sprouts). Entrees without the ingredients may be automatically tagged as appropriate. This puts the similarity potential together for the guest and the entree and supports a Stable Marriage match. This distance can be especially useful in catered meals settings where meals selections are pre-made by a host with little or no input from the guests. A chef sees who is a far distance from the meal that the system matched the guest with, and can revise the menu accordingly.

Once people are matched to meals, suggestions may be provided according to the type of service provided by the restaurant or other meal provider. For example, for station service, guests can be told which stations they should consider. For plate service, servers can be told which plates go to which guest by ID or name. The guest can then use a smart device at their seating location to notify the server of where the guest is seated. For box lunch service, guests can be told which box lunch they should choose/has been matched for them.

As an alternative to using the stable marriage algorithm in some embodiments, one or more machine learning models can be used for meal matching. More specifically, a neural network or similar machine learning model can be trained to transform profiles into a list of matches. For example, pre-processing can be performed on a user's food profile to extract a list of profile items with severity attributes. Similarly, a business profile can be pre-processed to extract menu items and severity tags. The neural network can then be used to generate a similarity measurement for each menu item quantifying its similarity to the user's profile.

### EXAMPLE INTERFACES

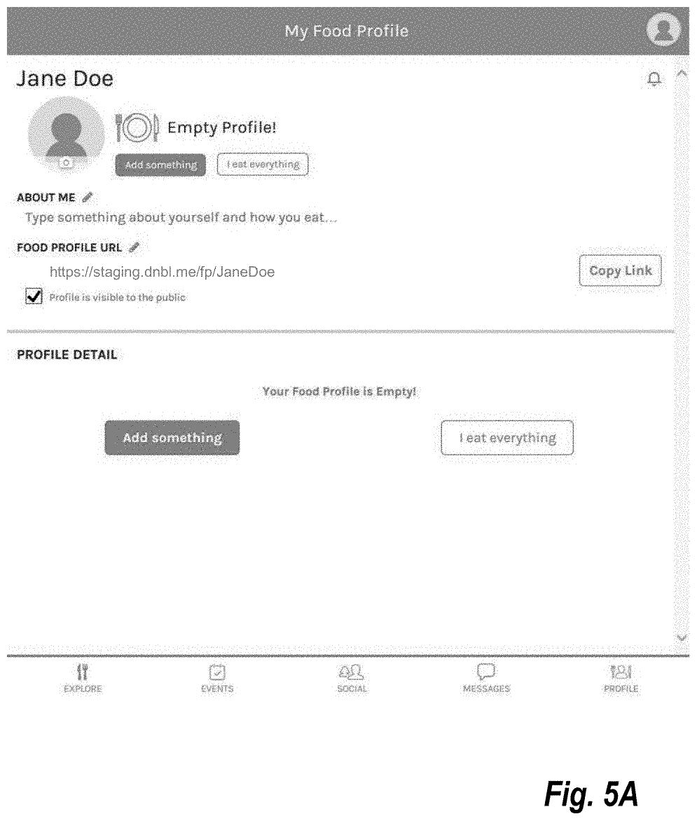

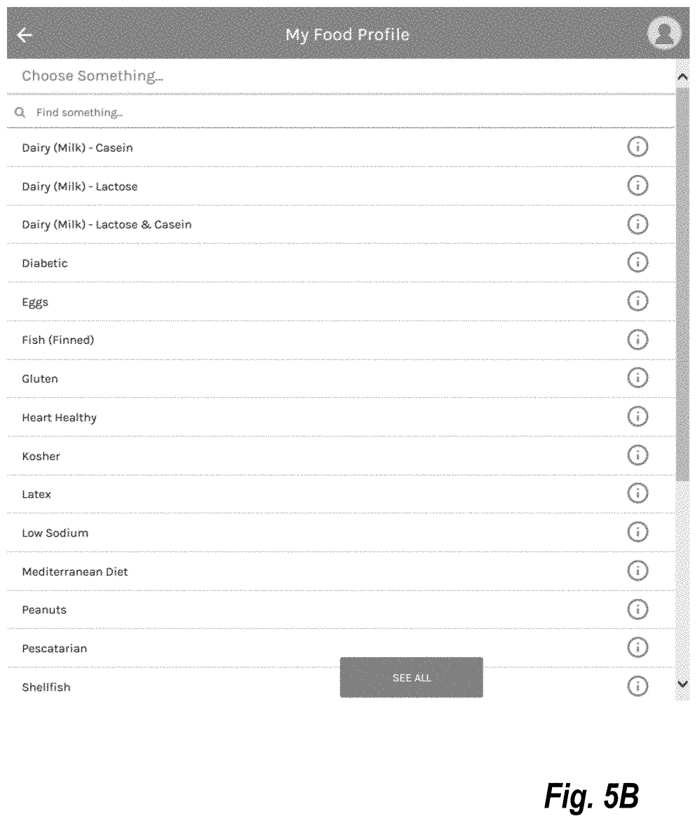

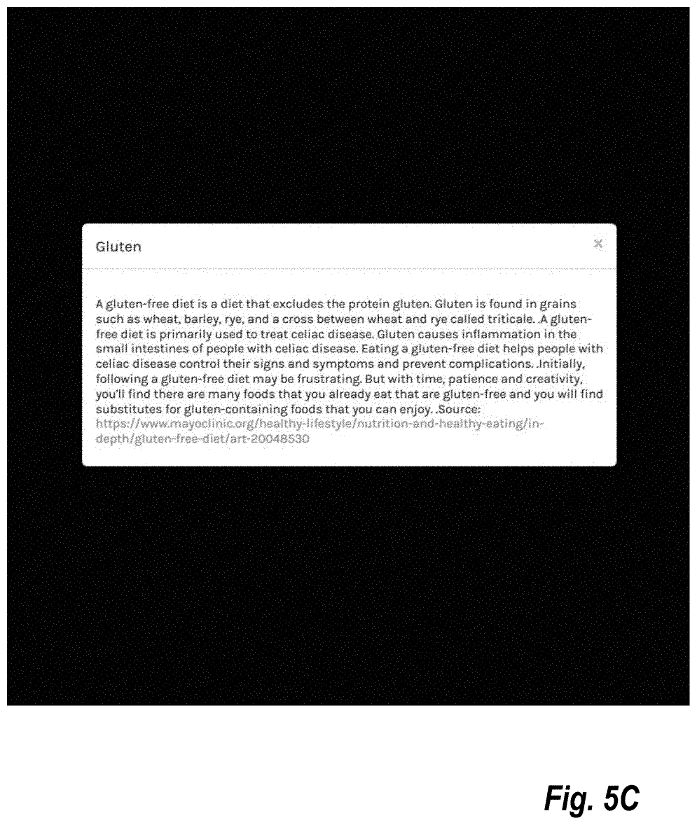

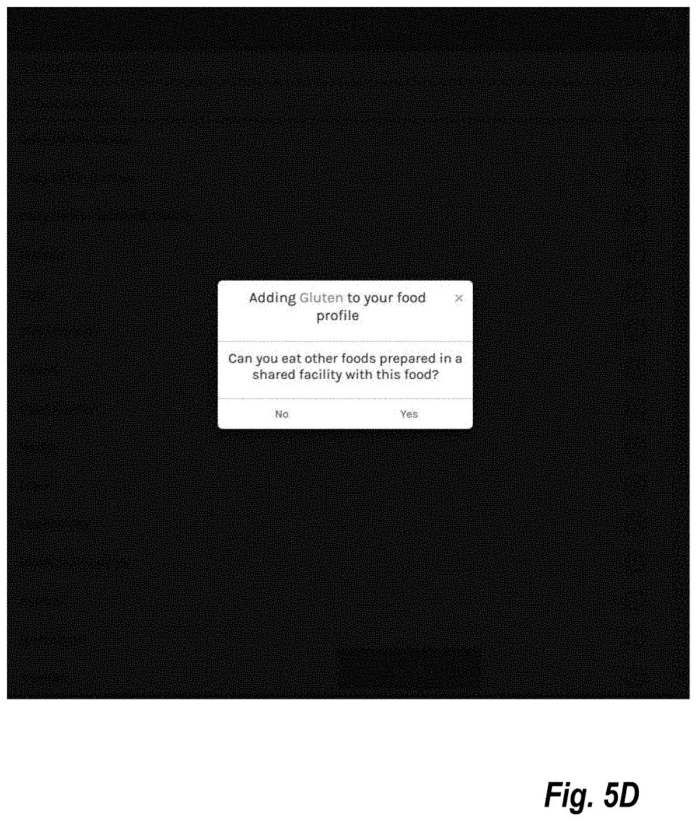

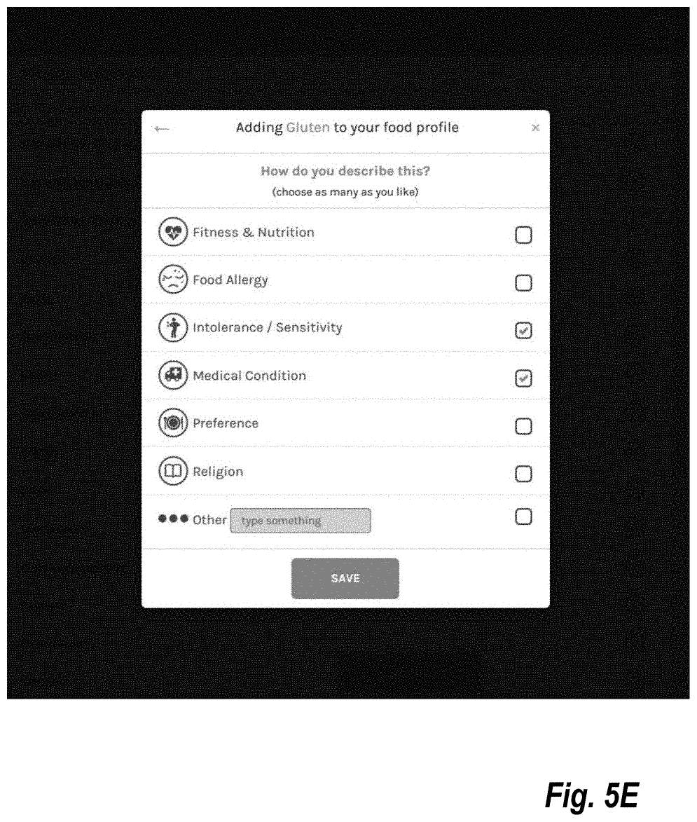

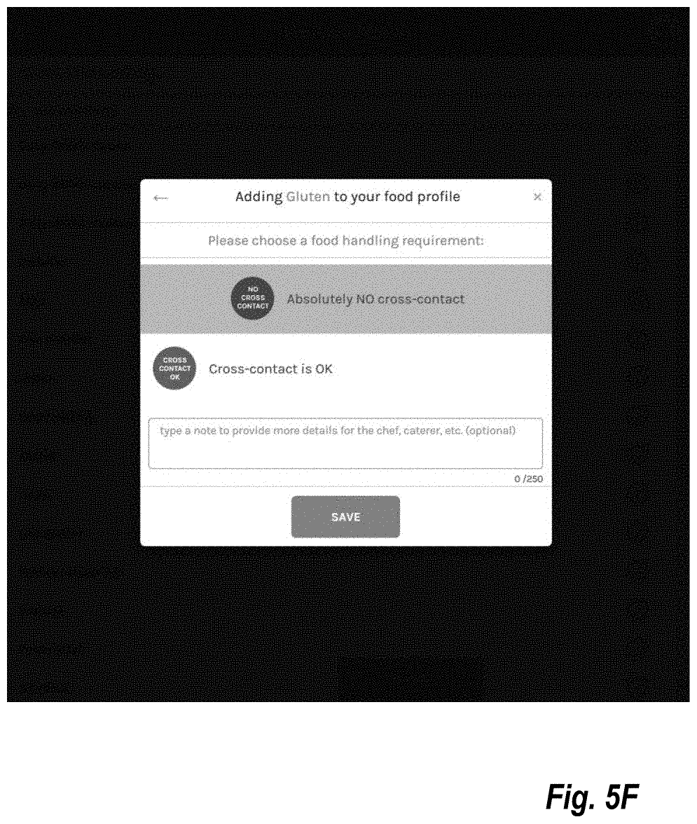

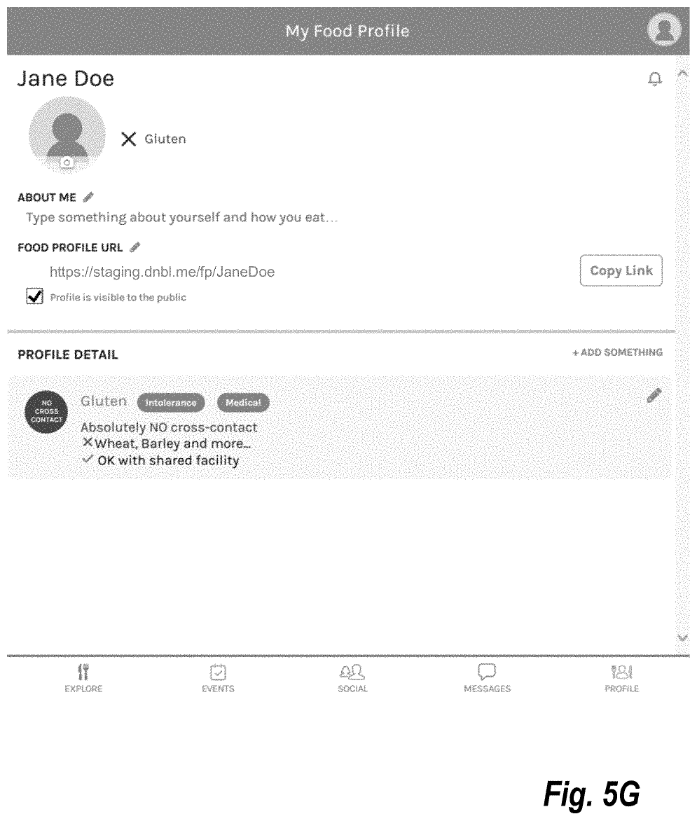

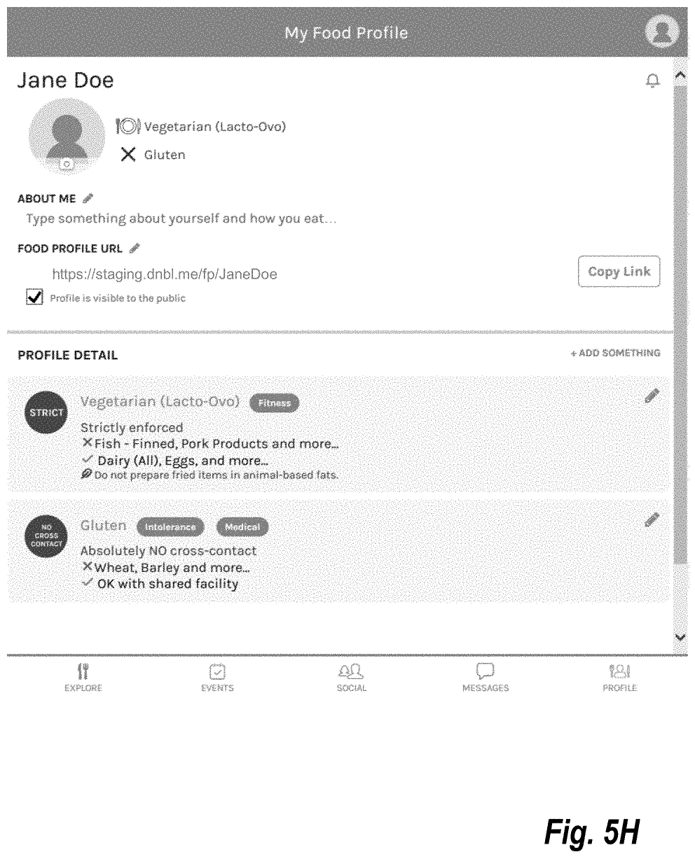

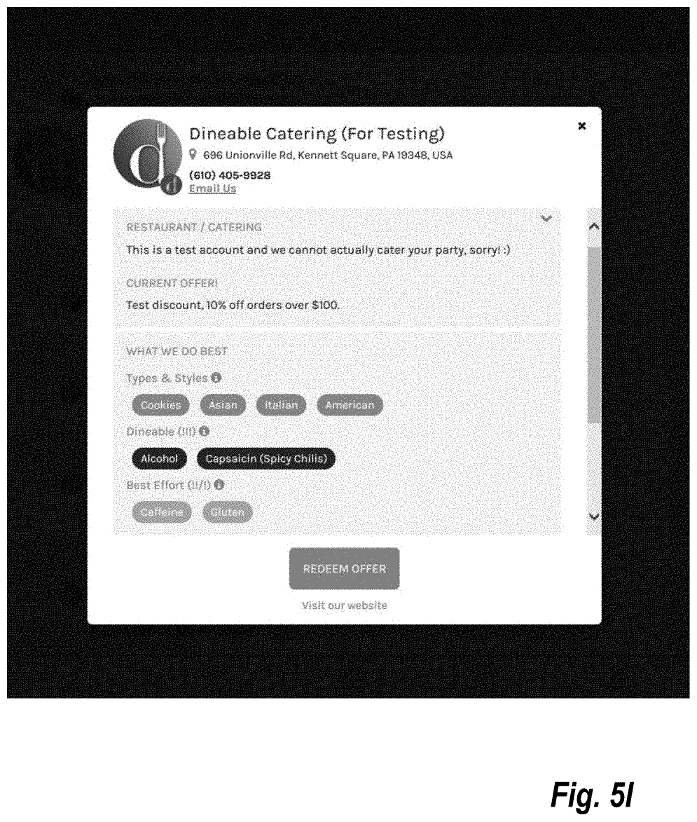

FIGS. 5A-5L show a series of graphical user interfaces (GUIs) for creating and managing food profiles, according to some embodiments. These GUIs can be displayed, for example, in a mobile app or webpage. FIG. 5A shows an example food profile created for a user named “Jane Doe.” When first created, the profile is empty and the user can add items by clicking on the “Add something” button. Alternatively the user can just activate the button “I eat everything” to indicate that no restrictions should be applied to the food profile. FIG. 5B shows the GUI presented after the user activates the “Add something” button. In this GUI, users can add an item by clicking on a desired item. If more information is required to understand the meaning of an item, the user can click on the information symbol (the lower case “i” on the right-hand side of the item). For example, FIG. 5C shows the information presented when the user requests information about “Gluten.”

FIG. 5D shows the GUI presented after the user indicates that he or she wants to add gluten to the food profile. As shown in FIG. 5D, this GUI provides a yes/no modal that asks if the user can eat other foods prepared in a shared facility with the food. The GUI shown in FIG. 5E allows the user to indicate the reason for the dietary restriction (e.g., fitness, allergy, intolerance, medical condition, etc.). The GUI shown in FIG. 5F allows the user to designate a severity, in this case whether cross-contact with gluten products is acceptable or not.

Once the user has proceeded through FIGS. 5D-5F, the gluten restriction is added to the user's food profile as shown in FIG. 5G. The user can follow a similar process to add other dietary restriction, which may then be reflected in the food profile. For example, FIG. 5H shows a GUI updated after the user adds a vegetarian dietary restriction. Finally, FIG. 5I shows an example of the GUI used for displaying business profile information, according to some embodiments.

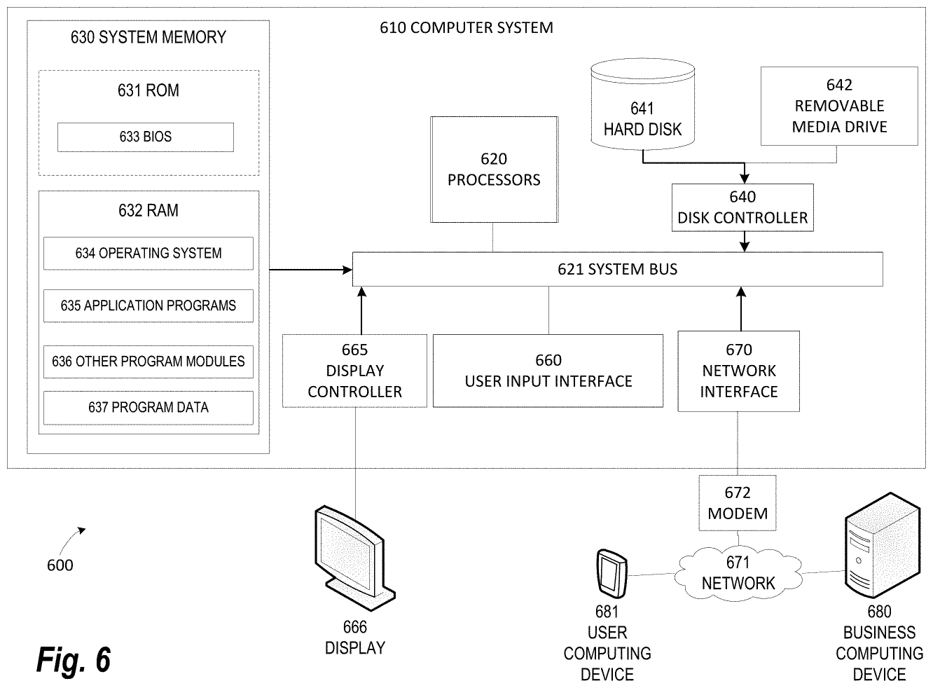

FIG. 6 illustrates an exemplary computing environment 600 within which embodiments of the invention may be implemented. In some embodiments, the computing environment 600 may be used to implement the Dietary Profile Management System 110 with one or more executable applications. Computers and computing environments, such as computer system 610 and computing environment 600, are known to those of skill in the art and thus are described briefly here.

As shown in FIG. 6, the computer system 610 may include a communication mechanism such as a bus 621 or other communication mechanism for communicating information within the computer system 610. The computer system 610 further includes one or more processors 620 coupled with the bus 621 for processing the information. The processors 620 may include one or more central processing units (CPUs), graphical processing units (GPUs), or any other processor known in the art.

The computer system 610 also includes a system memory 630 coupled to the bus 621 for storing information and instructions to be executed by processors 620. The system memory 630 may include computer readable storage media in the form of volatile and/or nonvolatile memory, such as read only memory (ROM) 631 and/or random access memory (RAM) 632. The system memory RAM 632 may include other dynamic storage device(s) (e.g., dynamic RAM, static RAM, and synchronous DRAM). The system memory ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system (BIOS) 633 containing the basic routines that helps to transfer information between elements within computer system 610, such as during start-up, may be stored in ROM 631. RAM 632 may contain data and/or program modules that are immediately accessible to and/or presently being operated on by the processors 620. System memory 630 may additionally include, for example, operating system 634, application programs 635, other program modules 636 and program data 637.

The computer system 610 also includes a disk controller 640 coupled to the bus 621 to control one or more storage devices for storing information and instructions, such as a hard disk 641 and a removable media drive 642 (e.g., floppy disk drive, compact disc drive, tape drive, and/or solid state drive). The storage devices may be added to the computer system 610 using an appropriate device interface (e.g., a small computer system interface (SCSI), integrated device electronics (IDE), Universal Serial Bus (USB), or FireWire).

The computer system 610 may also include a display controller 665 coupled to the bus 621 to control a display 666, such as a cathode ray tube (CRT) or liquid crystal display (LCD), for displaying information to a computer user. The computer system includes an input interface 660 and one or more input devices, such as a keyboard and a pointing device, for interacting with a computer user and providing information to the processor 620. The pointing device, for example, may be a mouse, a trackball, or a pointing stick for communicating direction information and command selections to the processor 620 and for controlling cursor movement on the display 666. The display 666 may provide a touch screen interface which allows input to supplement or replace the communication of direction information and command selections by the pointing device.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium, such as a hard disk 641 or a removable media drive 642. The hard disk 641 may contain one or more datastores and data files used by embodiments of the present invention. Datastore contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processor 620 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 641 or removable media drive 642. Non-limiting examples of volatile media include dynamic memory, such as system memory 630. Non-limiting examples of transmission media include coaxial cables, copper wire, and fiber optics, including the wires that make up the bus 621. Transmission media may also take the form of acoustic or light waves, such as those generated during radio wave and infrared data communications.

The computing environment 600 may further include the computer system 610 operating in a networked environment using logical connections to one or more remote computers, such as business computing device 680 and user computing device 681. These devices are used by the business and users, respectively, to interact with the dietary profile management system executed by the computer system 610. The business computing device 680 and user computing device 681 may be, for example, a personal computer (laptop or desktop), a mobile device, a server, a network PC, and typically includes many or all of the elements described above relative to computer system 610. When used in a networking environment, computer system 610 may include modem 672 for establishing communications over a network 671, such as the Internet. Modem 672 may be connected to bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., business computing device 680). The network 671 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f), unless the element is expressly recited using the phrase “means for.”

We claim:

1. A computer-implemented method for selecting meals for a user, the method comprising:
creating a food profile comprising a first set of tags describing one or more of dietary restrictions, preferences, special diets and dietary habits associated with a user;
creating a business profile comprising a second set of tags describing a plurality of meals served by a business; and
performing a matching process using the food profile and the business profile to identify one or more of the meals meeting at least one of the dietary restrictions, the preferences, the special diets, and the dietary habits of the user specified in the food profile.

2. The method of claim 1, further comprising:
providing a list of the identified meals to the user.

3. The method of claim 1, further comprising:
providing a menu for the business to the user, wherein the menu is filtered to only include the identified meals.

4. The method of claim 1, further comprising:
providing the food profile of the user to a food preparer of the business.

5. The method of claim 4, wherein the food profile is provided to the business in response to determining that the user is located within a pre-determined proximity of the business or the user is in the business.

6. The method of claim 4, wherein the food profile is provided to the business without any personally identifiable information of the user.

7. The method of claim 1, wherein the food profile includes a severity measurement for each dietary restriction.

8. The method of claim 1, wherein one or more ingredients are identified for each dietary restriction and the first set of tags specify whether cross-contact with the ingredients is permissible.

9. The method of claim 1, wherein the matching process is performed using a stable marriage algorithm.

10. The method of claim 9, wherein the stable marriage algorithm utilizes a values variable set using the first set of tags and the second set of tags.

11. The method of claim 10, wherein the stable marriage algorithm utilizes an interest variable set one or more dietary preferences of the user.

12. The method of claim 11, wherein the stable marriage algorithm utilizes an age variable set with severity measurement corresponding to the values variable or the interest variable.

13. A computer-implemented method for managing user dietary restrictions associated with an event, the method comprising:
receiving an indication of an event scheduled for a business;
identifying one or more attendees of the event;
retrieving food profiles for the attendees, wherein each food profile comprises one or more tags describing one or more of dietary restrictions, preferences, special diets and dietary habits of an attendee; and
notifying the business of any dietary restrictions, any preferences, any special diets, and any dietary habits of the attendees specified in the food profiles.

14. The method of claim 13, further comprising:
retrieving a business profile for the business comprising a list of meals served by the business and tags describing one or more of dietary restrictions, preferences, special diets, and dietary habits associated with each meal;
for each attendee, using the food profile of the attendee and the business profile to identify one or more suggested meals for the attendee;
for each attendee, notifying the attendee of the suggested meals identified for the attendee.

15. The method of claim 13, further comprising:
retrieving a business profile for the business comprising a list of meals served by the business and tags describing one or more of dietary restrictions, preferences, special diets, and dietary habits associated with each meal;
using the business profile and the food profiles to identify one or more suggested meals meeting any dietary restrictions, any preferences, any special diets, and any dietary habits of the attendees specified in the food profiles.

16. The method of claim 13, further comprising:
receiving a message from the business directed at one of the attendees, wherein the message indicates whether the business can accommodate any dietary restrictions, any preferences, any special diets, and any dietary habits of the attendee specified in a corresponding food profile;
identifying contact information for the attendee; and
transmitting the message to the attendee.

17. The method of claim 13, further comprising:
creating a database record linking each attendee to the event;
detecting a change to the food profile of one of the attendees; and
communicating the change to the food profile to the business.

18. The method of claim 17, further comprising:
after detecting the change to the food profile, requesting confirmation from the corresponding attendee that the change should be shared with the business, and
wherein the change is only communicated to the food profile if the corresponding attendee provides the confirmation.

19. A system for managing dietary restriction, preferences, special diets, and/or dietary habits information, the system comprising:
a database storing (i) a food profile comprising a first set of tags describing one or more dietary restrictions, preferences, special diets, and dietary habits associated with a user and (ii) a business profile comprising a second set of tags describing a plurality of meals served by a business; and
one or more computers configured to identify one or more of the meals meeting any dietary restrictions, any preferences, any special diets, any dietary habits of the user using the food profile and the business profile.

20. The system of claim 19, further comprising:
one or more physically printed items for notifying staff of the business of the dietary restrictions associated with the user when the user places a meal order with the business.
